(19) United States
(12) Patent Application Publication
(10) Pub. No.: US 2025/0140968 A1
(43) Pub. Date: May 1, 2025

(54) BATTERY MODULE

(71) Applicants: HYUNDAI MOTOR COMPANY, SEOUL (KR); KIA CORPORATION, SEOUL (KR)

(72) Inventor: Gun Goo Lee, Suwon-si (KR)

(73) Assignees: HYUNDAI MOTOR COMPANY, SEOUL (KR); KIA CORPORATION, SEOUL (KR)

(21) Appl. No.: 18/794,775

(22) Filed: Aug. 5, 2024

(30) Foreign Application Priority Data
Oct. 30, 2023 (KR) 10-2023-0146896

(51) Int. Cl. H01M 10/6552; H01M 10/613; H01M 10/653; H01M 10/6555

(52) U.S. Cl. CPC H01M 10/6552; H01M 10/613; H01M 10/653; H01M 10/6555

(57) ABSTRACT

A battery module includes a battery cell including a plurality of battery cells, a cooling member located at one end of the battery cell, and a plurality of heat transfer members, each of the heat transfer members being configured to discharge heat from each of the battery cells to the cooling member. The heat transfer members include a plurality of first heat transfer parts, each of the first heat transfer parts being located along a corresponding one of one side surfaces of the respective battery cells, and a plurality of second heat transfer parts, each of the second heat transfer parts being configured to at least partially surround a corresponding one of one ends of the respective battery cells, each of the one ends being adjacent to the cooling member.

### CROSS REFERENCE TO RELATED APPLICATIONS

This application claims, under 35 U.S.C. § 119 (a), the benefit of priority from Korean Patent Application No. 10-2023-0146896, filed on Oct. 30, 2023, the entire contents of which are incorporated herein by reference.

### BACKGROUND

### (a) Technical Field

The present disclosure relates to a battery module. More particularly, it relates to a battery pack configured to improve cooling performance by allowing a pulsating heat pipe (PHP) to at least partially surround one side surface and one end of each battery cell.

### (b) Background Art

Recently, there has been increasing demand for eco-friendly electric vehicles. In the future, demand for electric vehicles is expected to be higher than demand for an internal combustion engine vehicle that has been mainly used so far. Accordingly, there has also been increasing demand for a battery having high performance and high voltage and serving as a major component of electric vehicles.

Two main types of batteries used in electric vehicles are valve regulated lead-acid batteries (VRLA) and lithium-ion batteries. Currently, VRLA batteries are mainly used in electric vehicles. However, demand for lithium-ion batteries is expected to dramatically increase in consideration of a fast charging speed of lithium-ion batteries and a high energy density thereof.

Lithium-ion batteries are commonly used not only in electric vehicles but also in an energy storage system (ESS).

However, lithium-ion batteries are very sensitive to high temperatures. Specifically, a high temperature causes sharp deterioration in efficiency and performance of lithium-ion batteries. Additionally, excessive temperature rise causes thermal runaway due to dissolution of electrolytes, leading to a serious accident such as fire.

In view of increasing demand for electric vehicle batteries having high performance and high voltage with expansion of the electric vehicle market, and increasing demand for an ESS with expansion of new and renewable energy production, the use of the lithium-ion batteries is expected to continuously increase in the further. Accordingly, it is necessary to develop an efficient battery thermal management module.

Currently, as a thermal management method of cooling a battery, for example, there are a method using a cooling plate having a flow path formed therein and a method of absorbing and dissipating heat through a metal heat dissipation fin.

Examples of an indicator used to evaluate cooling performance of a battery cooling method include a maximum temperature in a battery cell and a maximum temperature difference in a battery cell. A temperature difference in a battery cell generates thermal stress due to a difference in degree of thermal expansion, which may cause physical damage.

A cooling method using a metal heat dissipation fin may not have high cooling performance. A battery cooling method using a cooling plate having a flow path formed therein has high cooling performance as compared with the cooling method using the metal heat dissipation fin. However, in the case of the battery cooling method using the cooling plate, a long flow path formed in the cooling plate causes a high pressure drop and, as such, only a small flow rate may be sent at the same pumping power. Accordingly, only a small heat capacity is provided. As a result, although cooling fluid enables efficient cooling performance at the inlet end of the flow path, the temperature of fluid rises at the outlet end of the flow path and, as such, efficiency in cooling performance at the outlet end of the flow path is lower than efficiency in cooling performance at the inlet end of the flow path. That is, since a large temperature gradient is formed at the inlet end of the flow path and the outlet end thereof, it is impossible to efficiently perform heat management under high heat generation.

The above information disclosed in this Background section is only for enhancement of understanding of the background of the disclosure, and therefore it may contain information that does not form the prior art that is already known in this country to a person of ordinary skill in the art.

### SUMMARY

The present disclosure has been made in an effort to solve the above-described problems associated with the prior art, and it is an object of the present disclosure to provide a battery module including a heat transfer member so as to improve heat dissipation performance at the upper end of a battery cell and the lower end thereof.

Further, the present disclosure provides a battery module configured to increase the size of a cooling area by providing a heat transfer member including a first heat transfer part and a second heat transfer part, in which the heat transfer member is formed of a pulsating heat pipe.

The objects of the present disclosure are not limited to the above-mentioned objects, and other technical objects not mentioned herein will be clearly understood by the following description and will be more clearly understood by embodiments of the present disclosure. Additionally, the objects of the present disclosure may be realized by means indicated in the scope of the claims and a combination thereof.

In one aspect, the present disclosure provides a battery module including a battery cell including a plurality of cells, a cooling member located at one end of the battery cell, and a plurality of heat transfer members, each of the heat transfer members being configured to discharge heat from each of the battery cells to the cooling member, wherein the heat transfer members include a plurality of first heat transfer parts, each of the first heat transfer parts being located along a corresponding one of one side surfaces of the respective battery cells, and a plurality of second heat transfer parts, each of the second heat transfer parts being configured to at least partially surround a corresponding one of one ends of the respective battery cells, each of the one ends being adjacent to the cooling member.

In a preferred embodiment, the battery module may further include a gap filler located between the second heat transfer parts and the cooling member.

In another preferred embodiment, each of the second heat transfer parts may be at least partially inserted into the gap filler and located therein.

In still another preferred embodiment, each of the second heat transfer parts may have a length set corresponding to a viscosity of the gap filler.

In yet another preferred embodiment, each of the heat transfer members may be formed of a pulsating heat pipe and may include one sealed pipe having working fluid partially filled therein, and the one sealed pipe may surround the first heat transfer part and is bent to surround the second heat transfer part.

In still yet another preferred embodiment, the pulsating heat pipe may be located between a cooling area in which the cooling member is located and a heating area adjacent to the other end of the battery cell, wherein the other end may be located far away from the cooling member.

In a further preferred embodiment, each of the second heat transfer parts may have a length of 3.5 mm.

In another aspect, the present disclosure provides a battery module including a battery cell including a plurality of cells, a cooling member located at one end of the battery cell, and a plurality of heat transfer members, each of the heat transfer members being formed of a pulsating heat pipe configured to discharge heat from each of the battery cells to the cooling member, wherein the heat transfer members include a plurality of first heat transfer parts, each of the first heat transfer parts being located along a corresponding one of one side surfaces of the respective battery cells, and a plurality of second heat transfer parts, each of the second heat transfer parts being configured to at least partially surround a corresponding one of one ends of the respective battery cells, each of the one ends being adjacent to the cooling member.

In a preferred embodiment, the battery module may further include a gap filler located between the second heat transfer parts and the cooling member.

In another preferred embodiment, each of the second heat transfer parts may be at least partially inserted into the gap filler and located therein.

In still another preferred embodiment, each of the second heat transfer parts may have a length set corresponding to a viscosity of the gap filler.

In yet another preferred embodiment, the pulsating heat pipe may include one sealed pipe having working fluid partially filled therein, wherein the one sealed pipe may surround the first heat transfer part and may be bent to surround the second heat transfer part.

In still yet another preferred embodiment, the pulsating heat pipe may be located between a cooling area in which the cooling member is located and a heating area adjacent to the other end of the battery cell, wherein the other end may be located far away from the cooling member.

In a further preferred embodiment, each of the second heat transfer parts may have a length of 3.5 mm.

Other aspects and preferred embodiments of the disclosure are discussed infra.

It is understood that the terms “vehicle”, “vehicular”, and other similar terms as used herein are inclusive of motor vehicles in general, such as passenger automobiles including sport utility vehicles (SUV), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, vehicles powered by both gasoline and electricity.

### BRIEF DESCRIPTION OF THE FIGURES

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 is a perspective view showing a battery module according to an embodiment of the present disclosure;

FIG. 2 is a cross-sectional view taken along line A-A of the battery module according to the embodiment of the present disclosure;

FIG. 3 shows a configuration of a heat transfer member coupled to a battery cell according to the embodiment of the present disclosure; and

FIG. 4 shows a heat exchange relationship of the heat transfer member including a pulsating heat pipe according to the embodiment of the present disclosure.

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

Hereinafter, reference will be made in detail to various embodiments of the present disclosure, examples of which are illustrated in the accompanying drawings and described below. While the disclosure will be described in conjunction with exemplary embodiments, it will be understood that present description is not intended to limit the disclosure to the exemplary embodiments. On the contrary, the disclosure is intended to cover not only the exemplary embodiments, but also various alternatives, modifications, equivalents, and other embodiments, which may be included within the spirit and scope of the disclosure as defined by the appended claims. The present embodiments are provided to more fully explain the disclosure to those of ordinary knowledge in the art.

Terms such as “part”, “unit”, and “module” described in the specification mean a unit configured to process at least one function or operation, and the unit may be implemented by hardware or software or a combination of hardware and software.

The terms used in the present application are used only to describe specific embodiments and are not intended to limit the present disclosure. Singular forms are intended to include plural forms as well, unless the context clearly indicates otherwise.

Meanwhile, in this specification, terms such as “first” and “second” are used to describe various components having the same names, and the terms are used only for the purpose of distinguishing one component from other components. The components are not limited by the terms in the following description.

Hereinafter, embodiments will be described in detail with reference to the accompanying drawings. In describing the embodiments with reference to the accompanying drawings, the same or corresponding components will be denoted by the same reference numerals and redundant description thereof will be omitted.

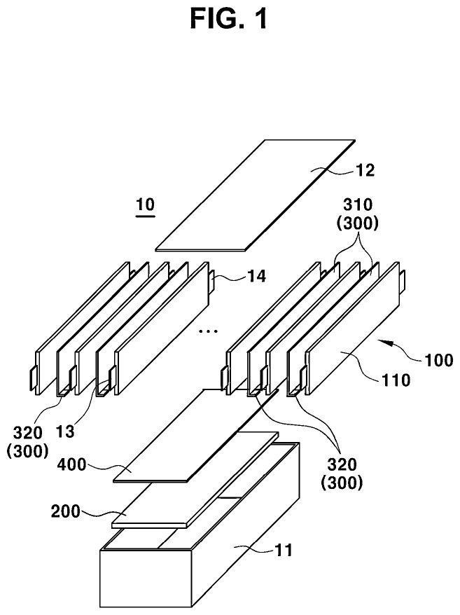

FIG. 1 is a perspective view showing a battery module 10 according to an embodiment of the present disclosure.

Referring to FIG. 1, the battery module 10 according to the present disclosure includes a battery cell 100 including a plurality of cells 110, a cooling member 200 configured to cool the battery cell 100, heat transfer members 300 configured to discharge heat generated from the plurality of cells 110 to the cooling member 200, and a case 11 configured to house the battery cell 100, the cooling member 200, and the heat transfer members 300 therein. Each of the heat transfer members 300 includes an inlet and an outlet configured to allow cooling fluid to flow therethrough.

Each of the heat transfer members 300 includes a first heat transfer part 310 and a second heat transfer part 320. Here, the first heat transfer part 310 is extended to have a straight line and located between two cells 110, and one side surface thereof is in contact with the battery cell 110. The second heat transfer part 320 is configured to at least partially surround one end of the battery cell 110, in which the one end is located adjacent to the cooling member 200.

The heat transfer member 300 contains refrigerant therein, and the case 11 that houses the refrigerant is made of a material having excellent thermal conductivity. Accordingly, cooling of the battery cell 110 and heat transfer between the cells 110 may be performed through the heat transfer member 300. Further, a temperature difference between the upper part and the lower part of the heat transfer member 300 may be generated through the second heat transfer part 320, thereby forming a heating area 500 and a cooling area 600. Heat generated from the battery cell 110 may be discharged to the cooling member 200 through the heat transfer member 300.

Specifically, the cooling member 200 adopted to cool the battery cell 110 is disposed at the lower part of the battery cell 100 including a plurality of cells 110, and a gap filler 400 is disposed between the battery cell 100 and the cooling member 200. Accordingly, heat of the battery cell 110 may be discharged to the cooling member 200 through the heat transfer member 300. Accordingly, the temperature of the battery cell 110 may be maintained within a certain range.

After the battery cell 100, the heat transfer members 300, and the cooling member 200 are housed in the case 11, the upper open surface of the case 11 is covered and sealed with the top plate 12. In this manner, the battery module 10 is assembled.

Further, the case 11 may be provided in the form of a mono-frame or a U-frame in which an end plate is assembled in a direction in which an electrode terminal protrudes, and a method of sealing the battery module 10 may vary depending on the shape of the case 11.

The cooling member 200 may be configured to allow refrigerant to flow therethrough in the case 11, and the cooling member 200 may have an inlet formed therein and configured to allow the refrigerant to be introduced thereinto and an outlet formed therein and configured to allow the refrigerant to be discharged therefrom. Further, refrigerant may be supplied from the outside of the case 11 and the refrigerant may be discharged to the outside of the case 11.

The battery cell 110 may be a pouch type battery cell 110 in which an electrode assembly is housed in the pouch type battery case 11 made of a laminated sheet including a metal layer and a resin layer. Alternatively, the battery cell 110 may be a square battery cell 110 or a cylindrical battery cell 110 in which an electrode assembly is housed in a metal square can or a cylindrical can.

In addition, the battery cell 110 of the present disclosure is disclosed as an embodiment of a bidirectional pouch type battery cell 110 in which a positive lead 13 and a negative lead 14 protrude in opposite directions. It goes without saying that the battery cell 110 of the present disclosure may be a unidirectional pouch type battery cell 110 in which the positive lead 13 and the negative lead 14 protrude in the same direction.

The heat transfer member 300 of the present disclosure may be formed of a pulsating heat pipe (PHP). Here, the pulsating heat pipe may be formed of a plurality of channels connected to each other and configured to connect the heating area 500 to the cooling area 600 in a smooth form without a wick structure therein.

Moreover, the pulsating heat pipe of the present disclosure is formed of a bundle of smooth channels without a wick structure, thereby making it easy to form various shapes. Accordingly, as compared with existing devices, efficiency in space utilization is high and manufacturing processing is easy.

Heat is applied to the heat transfer member 300 in the heating area 500, air or coolant is applied thereto in the cooling area 600, and working fluid injected into a channel of the pulsating heat pipe pulsates between the heating area 500 and the cooling area 600. Thereafter, heat applied to the heat transfer member in the heating area 500 may be transferred to the cooling area 600 by movement of the pulsating working fluid. In other words, when the diameter of a channel falls below a certain value, working fluid filling the channel is provided in the form of a slug-train including a liquid slug and a gaseous slug. Here, the working fluid pulsates between the heating area 500 and the cooling area 600 due to a pressure difference between gases caused by evaporation and condensation. This pulsation enables heat to be effectively transferred from the heating area 500 to the cooling area 600.

Furthermore, the diameter of the channel is necessarily formed to be small so as to allow the working fluid to pulsate in the channel. Through this structure, the size of the overall shape of the heat transfer member 300 may be reduced.

In addition, since the pulsating heat pipe does not have a wick structure, the same may be implemented as a soft and bendable pipe. Accordingly, the pulsating heat pipe may be manufactured in various shapes.

According to the embodiment of the present disclosure, the battery heat transfer member 300 using the pulsating heat pipe may be formed as a single pipe having a plurality of channels of the pulsating heat pipe.

In addition, the battery module includes the battery cell 100 and the cooling member 200, and the gap filler 400 may be formed between the lower end of the battery cell 100 and the cooling member 200.

The battery cell 100 may be fixed to the cooling member 200. The composition of the gap filler 400 according to the above-described embodiment may be applied to and cured in a space between the battery cell 100 and the cooling member 200, thereby forming the gap filler 400.

The battery cell 100 may be stably fixed to the cooling member 200 by the gap filler 400. The gap filler may have stable curing properties and improved heat conduction properties.

According to the embodiment of the present disclosure, the composition of the gap filler 400 may have a low specific gravity and maintain a target hardness range in a predetermined time range. Therefore, the gap filler 400 may maintain stable hardness characteristics without impairing efficiency in an overall electric vehicle process or increasing the weight of a battery module.

Therefore, the gap filler 400 may have impact resistance and heat resistance to protect the battery cell 100 under high temperature conditions and provide sufficient heat dissipation characteristics.

Furthermore, the gap filler 400 may be provided as a heat conductive layer. For example, thermal conductivity of the gap filler 400 may be about 3 W/mK or more. For example, thermal conductivity of the gap filler 400 may be 10 W/mK or less. In the embodiment, thermal conductivity of the gap filler 400 may be 3 W/mK to 5 W/mK.

In the above-described thermal conductivity range, sufficient heat dissipation characteristics may be secured without excessively increasing the gap filler 400 or the specific gravity of the composition of the gap filler 400. As an example, the thermal conductivity may be measured according to the ASTM D5470 standard.

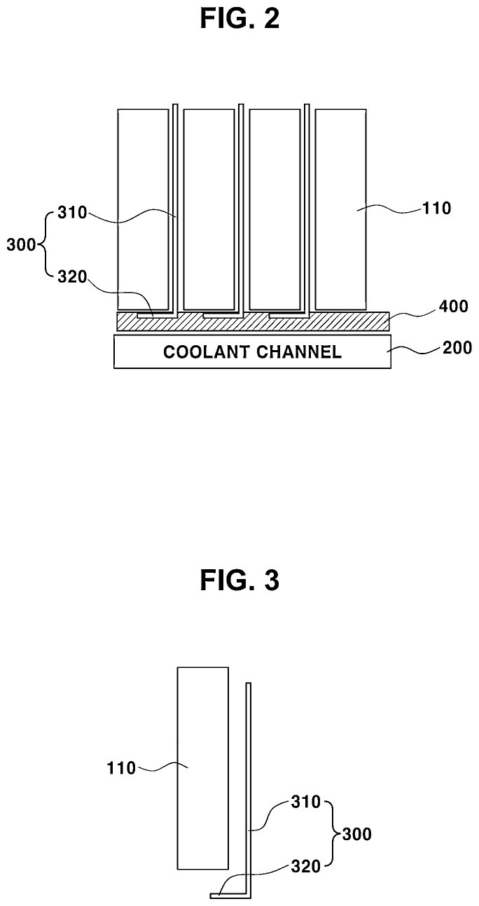

FIG. 2 is a side cross-sectional view of the battery module including the battery cell 110 according to the embodiment of the present disclosure, and FIG. 3 shows a configuration of the heat transfer member 300 coupled to one battery cell 110.

The cooling member 200 is located at the lower part of the battery cell 100 with a predetermined space therebetween and contains refrigerant therein. The cooling member 200 may include an inlet (not shown) configured to allow refrigerant to flow thereinto and an outlet (not shown) configured to allow circulating refrigerant to be discharged therefrom. The inlet and the outlet may be configured to be opened or closed under control of a valve. The shape and location of the valve are not particularly limited, and any type of valve known in the related art may be applied to the present disclosure as long as the valve may control the inflow and outflow of cooling fluid.

The gap filler 400 is located between the cooling member 200 and the battery cell 100. The heat transfer member 300 is located between the cells 110 and between the battery cell 110 and the gap filler 400. The heat transfer member 300 includes the first heat transfer part 310 located adjacent to one side surface of the battery cell 110 and the second heat transfer part 320 located between the gap filler 400 and the lower end of the battery cell 110.

The heat transfer member 300 including the first heat transfer part 310 and the second heat transfer part 320 may be configured as one heat pipe. Additionally, according to the embodiment of the present disclosure, the heat transfer member 300 is formed of a pulsating heat pipe, and the first heat transfer part 310 and the second heat transfer part 320 are formed through a sealed pipe 330.

At least a part of the second heat transfer part 320 is inserted into the gap filler 400. Furthermore, the second heat transfer part 320 is configured to extend in the width direction along at least a part of one end of the battery cell 110. Preferably, in the embodiment of the present disclosure, the second heat transfer part 320 is configured to have a length of 3.5 mm.

Furthermore, the length of the second heat transfer part 320 may be set corresponding to a viscosity of the gap filler 400. That is, the gap filler 400 is configured to be smoothly sprayed into a space between the cooling member 200 and the battery cell 110 so as to prevent void occurrence.

According to the embodiment of the present disclosure, a table shown below discloses data on a heat dissipation performance test using the heat transfer member 300 having the pulsating heat pipe (PHP) applied thereto. As a comparative example, the table discloses temperature distribution conditions of the battery cell 110 to which the heat transfer member 300 having properties of aluminum is applied.

Additionally, the table shows temperature distribution data at the upper end and the lower end of the battery cell 110 by using the heat transfer member 300 that has the pulsating heat pipe (PHP) applied thereto and includes only the first heat transfer part 310, and the heat transfer member 300 that has properties of aluminum and includes only the first heat transfer part 310.

TABLE 1

| | Surface of battery cell heating element | | | | |
|---|---|---|---|---|---|
| | | AL 1t | | PHP 1t | |
| | No | | First heat | | First heat |
| | application | First | transfer part + | First | transfer part + |
| | of heat | heat | second heat | heat | second heat |
| Heat dissipating | dissipating | transfer | transfer part | transfer | transfer part |
| material | material | part | (3.5 mm) | part | (3.5 mm) |
| Temperature at | 54.3 | 50.7 | 44.6 | 49.4 | 40.3 |
| upper end of | | | | | |
| battery cell | | | | | |
| (T1)° C. | | | | | |
| Temperature at | 37.3 | 41.6 | 33.8 | 42.4 | 34.8 |
| lower end of | | | | | |
| battery cell | | | | | |
| (T2)° C. | | | | | |
| Temperature | 17 | 9.1 | 10.8 | 7 | 5.5 |
| difference | | | | | |
| between upper | | | | | |
| and lower ends ° C. | | | | | |

### No Application of the Heat Transfer Member 300

When the heat transfer member 300 is not applied, the maximum temperature of the temperature T1 is 54° C., and a temperature difference between the temperature T1 and the temperature T2 is 17° C.

### Application of the First Heat Transfer Part 310

In the case of the heat transfer member 300 that has properties of aluminum without including the second heat transfer part 320, and the heat transfer member 300 that uses the pulsating heat pipe (PHP) without including the second heat transfer part 320, the temperatures T1 at the upper ends of the cells 110 of the two heat transfer members 300 are 50.7° C. and 49.4° C., respectively. Here, as compared with the temperature T1 at the upper end of the battery cell 110 to which the heat transfer member 300 is not applied, the temperature T1 of this case further drops by about 4° C. Here, effects of the heat transfer members 300 at the upper ends of the respective cells 110 are similar to each other. Further, a temperature difference between the upper end and the lower end of the battery cell 110 of the heat transfer member 300 having properties of aluminum is 9.1° C., and a temperature difference between the upper end and the lower end of the battery cell 110 of the heat transfer member 300 using the pulsating heat pipe is 7° C. In this case, the heat dissipation performance of the heat transfer member 300 using the pulsating heat pipe is superior to that of the heat transfer member 300 having properties of aluminum.

### Application of the First Heat Transfer Part 310 and the Second Heat Transfer Part 320

The temperature T1 of the heat transfer member 300 that has properties of aluminum and includes the first seat transfer part 310 and the second heat transfer part 320 is 44.6° C., and the temperature T1 of the heat transfer member 300 that uses the pulsating heat pipe (PHP) and includes the first seat transfer part 310 and the second heat transfer part 320 is 40.3° C. As shown in the table, the heat dissipation performance of this case is superior to that of the previous case in which the second heat transfer part 320 is not included. Additionally, in this case, the heat transfer member 300 using the pulsating heat pipe (PHP) has higher heat dissipation performance of about 4° C. or more as compared with the heat transfer member 300 having properties of aluminum. A temperature difference between the upper end and the lower end of the battery cell 110 of the heat transfer member 300 having properties of aluminum is 10.8° C., and a temperature difference between the upper end and the lower end of the battery cell 110 of the heat transfer member 300 using the pulsating heat pipe (PHP) is 5.5° C. Additionally, the temperature difference between the upper end and the lower end of the battery cell 110 of the heat transfer member 300 having properties of aluminum of this case is greater than the temperature difference between the upper end and the lower end of the battery cell 110 of the heat transfer member 300 having properties of aluminum of the previous case in which the second transfer part 320 is not included. In this case, since the second heat transfer part 320 is located adjacent to the cooling member 200, the temperature T2 at the lower end of the battery cell 110 is significantly reduced, but there is a limit to lowering the temperature T1 at the upper end of the battery cell 110.

On the other hand, in the case of the heat transfer member 300 that uses the pulsating heat pipe (PHP) and includes the first heat transfer part 310 and the second heat transfer part 320, as a temperature difference between the temperature T1 at the upper end of the battery cell 110 and the temperature T2 at the lower end of the battery cell 110 increases, thermal conductivity also increases, thereby having an effect of simultaneously lowering the temperature of the upper and lower ends of the battery cell 110. As described above, according to the embodiment of the present disclosure, the heat transfer member 300 that uses the pulsating heat pipe (PHP) and includes the first heat transfer part 310 and the second heat transfer part 320 provides high heat dissipation performance to both the upper and lower ends of the battery cell 110.

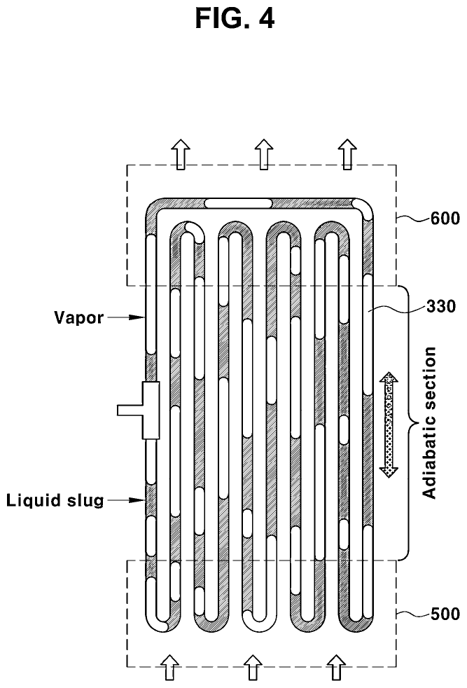

FIG. 4 shows a heat dissipation structure including the pulsating heat pipe according to the embodiment of the present disclosure.

As shown in the drawing, as the heat transfer member 300 of the present disclosure, the pulsating heat pipe is formed as the sealed pipe 330 located between the heating area 500 and the cooling area 600. Here, the sealed pipe 330 has working fluid partially filled therein. The sealed pipe 330 is formed as a channel structure, and the working fluid injected into the channel of the pulsating heat pipe pulsates between the heating area 500 and the cooling area 600.

More preferably, the working fluid located in the channel pulsates based on the channel structure located in the height direction of the battery cell 110, and heat applied to the heating area 500 may be transferred to the cooling area 600 by movement of the working fluid. More preferably, the working fluid filled in the channel of the pulsating heat pipe is provided in the form of a slug-train including a liquid slug and a gaseous slug. Therefore, the working fluid pulsates between the heating area 500 and the cooling area 600 due to evaporation and condensation, and this pulsation may enable heat to be effectively transferred from the heating area 500 to the cooling area 600.

As shown in the drawing, the heating area 500 is formed at a location facing an upper end of the battery cell 110, in which the upper end is located far from the cooling member 200, and the cooling area 600 is located at one end of the battery cell 110, in which the one end is close to the cooling member 200, and the second heat transfer part 320.

Additionally, since the second heat transfer part 320 provides an effect of increasing a contact area with the cooling area 600, a temperature difference between the heating area 500 and the cooling area 600 increases. Accordingly, this configuration may cause pulsation of the working fluid, thereby providing an effect of increasing heat dissipation performance through the pulsating heat pipe.

As is apparent from the above description, the present disclosure may achieve the following effects by combining the embodiments with the above-described configuration, combination, and use relationship.

The present disclosure has an effect of providing a battery module having improved heat dissipation performance by providing a second heat transfer part configured to surround a space between a battery cell and a cooling member.

In addition, the present disclosure has an effect of reducing a temperature difference between the upper end of the battery cell and the lower end thereof by using a heat transfer member providing a large cooling area.

The present disclosure has been described in detail with reference to preferred embodiments thereof, and the present disclosure may be used in various other combinations, modifications, and environments. That is, it will be appreciated by those skilled in the art that changes may be made in these embodiments without departing from the principles and spirit of the disclosure, the scope of which is defined in the appended claims and equivalents thereto. The embodiments describe the best mode to implement the technical idea of the present disclosure, and various changes required in specific application fields and uses of the present disclosure are also possible. Accordingly, the detailed description of the present disclosure is not intended to limit the present disclosure to the disclosed embodiments. Additionally, the scope of the appended claims should be construed as including other embodiments as well.

1. A battery module comprising:
a battery cell;
a cooling member located at one end of the battery cell; and
a plurality of heat transfer members, each of the plurality of heat transfer members being configured to discharge heat from the battery cell to the cooling member,
wherein each of the plurality of heat transfer members comprise:
a plurality of first heat transfer parts, each of the plurality of first heat transfer parts being located along a corresponding one side surface of the respective battery cells; and
a plurality of second heat transfer parts, each of the plurality of second heat transfer parts being configured to at least partially surround a corresponding one end of the respective battery cells, each of the corresponding one ends being adjacent to the cooling member.

2. The battery module of claim 1, further comprising a gap filler located between each of the plurality of second heat transfer parts and the cooling member.

3. The battery module of claim 2, wherein each of the plurality of second heat transfer parts is at least partially inserted into the gap filler.

4. The battery module of claim 2, wherein each of the plurality of second heat transfer parts has a length set corresponding to a viscosity of the gap filler.

5. The battery module of claim 1, wherein each of the plurality of first and second heat transfer members is formed of a pulsating heat pipe which is comprised of one sealed pipe having working fluid partially filled therein, and
wherein the one sealed pipe surrounds each of the plurality of first heat transfer parts which is extended to have a straight line and is bent to surround each of the plurality of second heat transfer parts.

6. The battery module of claim 5, wherein each of the pulsating heat pipes is positioned between a cooling area in which the cooling member is located and a heating area adjacent to an other end of the battery cell, wherein the other end is located at a distance away from the cooling member.

7. The battery module of claim 1, wherein each of the plurality of second heat transfer parts has a length of 3.5 mm.

8. A battery module comprising:
a battery cell;
a cooling member located at one end of the battery cell; and
a plurality of heat transfer members, each of the plurality of heat transfer members being formed of a pulsating heat pipe configured to discharge heat from the battery cell to the cooling member,
wherein the each of the plurality of heat transfer members comprise:
a plurality of first heat transfer parts, each of the plurality of first heat transfer parts being located along a corresponding one side surface of the respective battery cells; and
a plurality of second heat transfer parts, each of the plurality of second heat transfer parts being configured to at least partially surround a corresponding one end of the respective battery cells, each of the corresponding one ends being adjacent to the cooling member.

9. The battery module of claim 8, further comprising a gap filler located between each of the plurality of second heat transfer parts and the cooling member.

10. The battery module of claim 9, wherein each of the plurality of second heat transfer parts is at least partially inserted into the gap filler.

11. The battery module of claim 9, wherein each of the plurality of second heat transfer parts has a length set corresponding to a viscosity of the gap filler.

12. The battery module of claim 8, wherein the pulsating heat pipe comprises one sealed pipe having working fluid partially filled therein, and
wherein the one sealed pipe surrounds each of the plurality of first heat transfer parts and is bent to surround each of the plurality of second heat transfer parts.

13. The battery module of claim 12, wherein the pulsating heat pipe is located between a cooling area in which the cooling member is located and a heating area adjacent to an other end of the battery cell, wherein the other end is located at a distance away from the cooling member.

14. The battery module of claim 8, wherein each of the plurality of second heat transfer parts has a length of 3.5 mm.
